(19) United States
(12) Patent Application Publication
(10) Pub. No.: US 2013/0157732 A1
(43) Pub. Date: Jun. 20, 2013

(54) Cascade Pan

(71) Applicants: James M. Kopriva, Culbertson, NE (US); Robert Honas, Newton, KS (US); William H. Hasty, Hesston, KS (US)

(72) Inventors: James M. Kopriva, Culbertson, NE (US); Robert Honas, Newton, KS (US); William H. Hasty, Hesston, KS (US)

(21) Appl. No.: 13/326,312

(22) Filed: Dec. 14, 2011

(51) Int. Cl. A01F 12/44; A01D 41/00; B07B 9/00

(52) U.S. Cl. 460/100; 209/30

(57) ABSTRACT

A cascade pan may be disclosed. The cascade pan may comprise a surface located proximate a fan having an exhaust. The surface may comprise an upper portion arranged above a lower portion. The surface may define a plurality of openings and may be arranged to receive a portion of air exiting the exhaust.

### CROSS-REFERENCE TO RELATED APPLICATIONS

The current application is related to U.S. patent application Ser. No. ______, filed on ______, entitled “Dual Outlet Fan In Axial Flow combine,” and having attorney docket number A0832H, which is hereby incorporated by reference in its entirety.

### BACKGROUND

Equipment such as, for example, agricultural machines, may have a fan. The fan may be used to create airflow. The airflow may be used for various purposes such as, for example, cleaning and cooling equipment parts.

### BRIEF DESCRIPTION OF THE DRAWINGS

The accompanying drawings, which are incorporated in and constitute a part of this disclosure, illustrate various embodiments of the disclosure. In the drawings:

FIG. 1 is a diagram of a combine;

FIG. 2 is a schematic of a chaffer, sieve, and cascade pan assembly;

FIG. 3 is a diagram of a cascade pan; and

FIG. 4 is a flowchart showing a method for separating grain from material other than grain.

### DETAILED DESCRIPTION

### Overview

A cascade pan may be disclosed. The cascade pan may comprise a surface located proximate a fan having an exhaust. The surface may comprise an upper portion arranged above a lower portion. The surface may define a plurality of openings and may be arranged to receive a portion of air exiting the exhaust.

Both the foregoing general description and the following detailed description are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the detailed description.

### Example Embodiments

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Fans may be used within agricultural equipment to facilitate separating grain from material other than grain (MOG). Fans may be connected to a duct. The fan may produce an airstream. The airstream may be used to stratify the grain and the MOG. Once stratified, the grain may be sent to a storage bin and the MOG may be discarded.

While this disclosure describes cascade pans in the context of a combine, embodiments are not limited to an agricultural working environment. In other words, applications where a cascade pan may be desirable include not only agricultural equipment, but also include, for example, industrial, mining, and manufacturing applications.

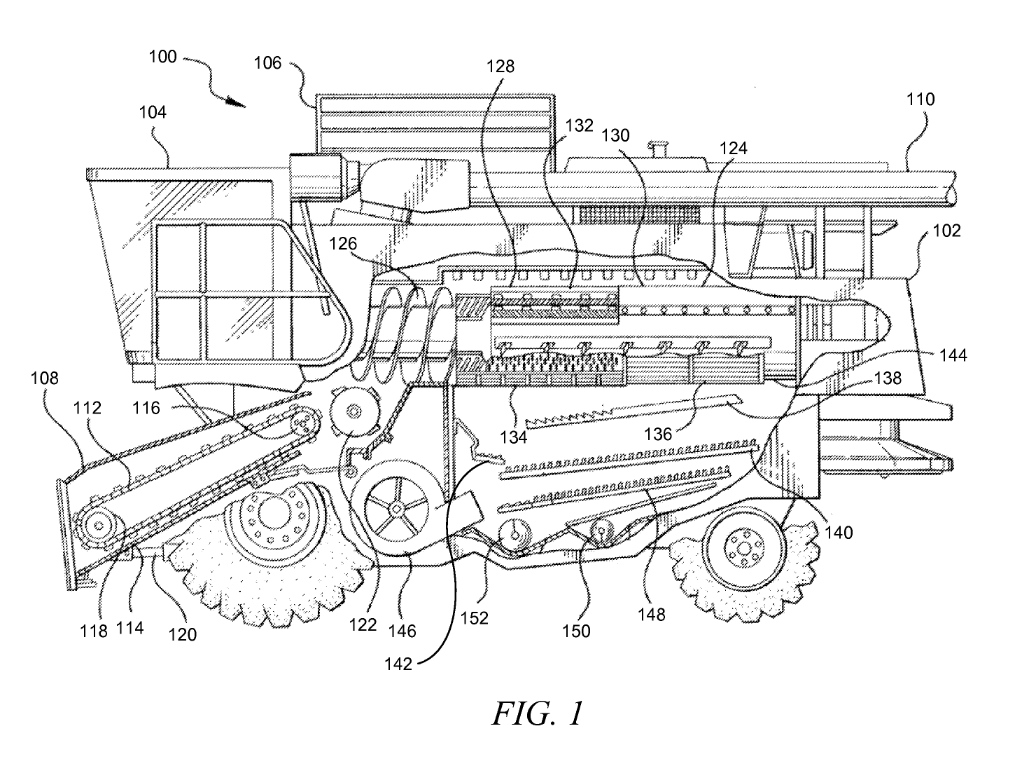

FIG. 1 is a diagram of a combine 100. Combine 100 may comprise a separator housing 102, an operator's work station and cab 104, a grain tank 106, and an elevator assembly 108. A swingable unloading auger assembly 110 may pivot to a position extending laterally outward to one side of combine 100 to unload grain tank 106. Unloading auger assembly 110 may swing inward to a storage position as shown in FIG. 1 when grain tank 106 is not being unloaded.

Elevator assembly 108 may have a conveyor 112 mounted in an elevator housing 114. Conveyor 112 may be trained around rear drive sprockets 116 and a front drum 118. Hydraulic linear actuators 120 may pivot elevator housing 114 to raise and lower the forward end of elevator housing 114.

Crop material may be fed to a feed beater 122 by conveyor 112 in elevator housing 114. Feed beater 122 may feed crop material to a separating rotor 124. Separating rotor 124 may comprise a feed section 126, a threshing section 128, and a separation section 130. Feed section 126 may move crop material in a spiral path about a generally horizontal fore and aft axis of rotation to separating rotor 124, toward threshing section 128. In threshing section 128, crop material may pass between a cylinder bar 132 and a concave 134 where grain may be threshed. Threshed grain, that is not separated by concave 134, may be separated in separation section 130 and may pass through a separation grate 136. A rotor pan 138 may convey grain and chaff forward and may deposit it on a chaffer 140. Before reaching chaffer 140, the grain, chaff, and MOG may pass a cascade pan 142. MOG may be discharged from separating rotor 124 through a rotor discharge 144.

Grain and MOG that may pass through concave 134 and separation grate 136 may fall to rotor pan 138. Rotor Pan 138 may convey grain and chaff forward and may deposit it on chaffer 140. The grain may be cleaned by chaffer 140 and a sieve 146 and air from a fan assembly 146. Chaff may be discharged from the rear of sieve 146 and chaffer 140. Clean grain may fall into a clean grain auger 150. The clean grain may be conveyed to grain tank 106 by clean grain auger 150 and an elevator (not shown). Tailings may fall into a returns auger 152 and may be conveyed to separating rotor 124 by returns auger and return elevators (not shown), where they may be threshed a second time.

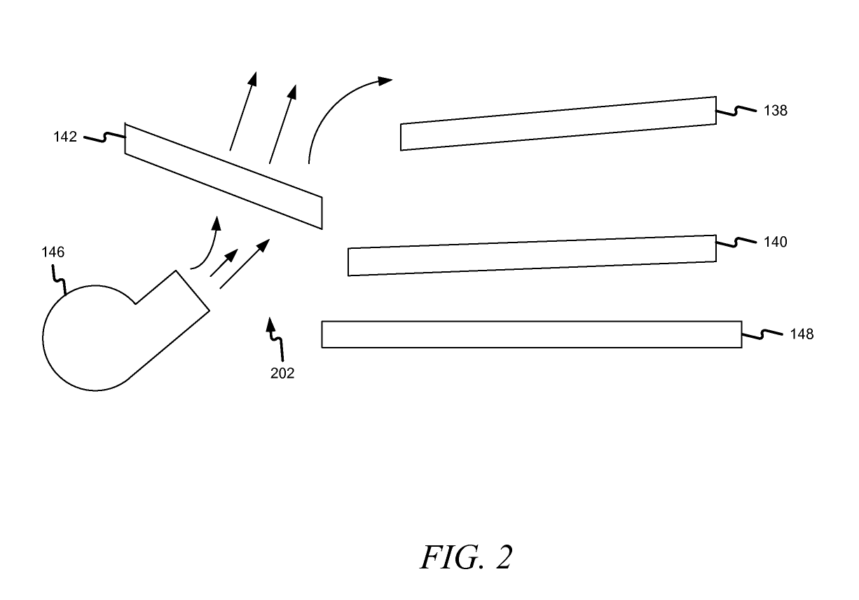

FIG. 2 is a schematic of chaffer 140's, sieve 148's, and cascade pan 142's orientation to on another. During operation, a crop (e.g., corn) may be separated into grain and MOG by concave 134. The grain and MOG may pass through separation grate 136 and travel to rotor pan 138. From rotor pan 138, the grain and MOG may travel toward cascade pan 142 and chaffer 140. As the grain and MOG falls from rotor pan 138 onto cascade pan 142, the grain and MOG may be further separated by air (as represented by arrows 202) that may be blown through cascade pan 142 from fan 146.

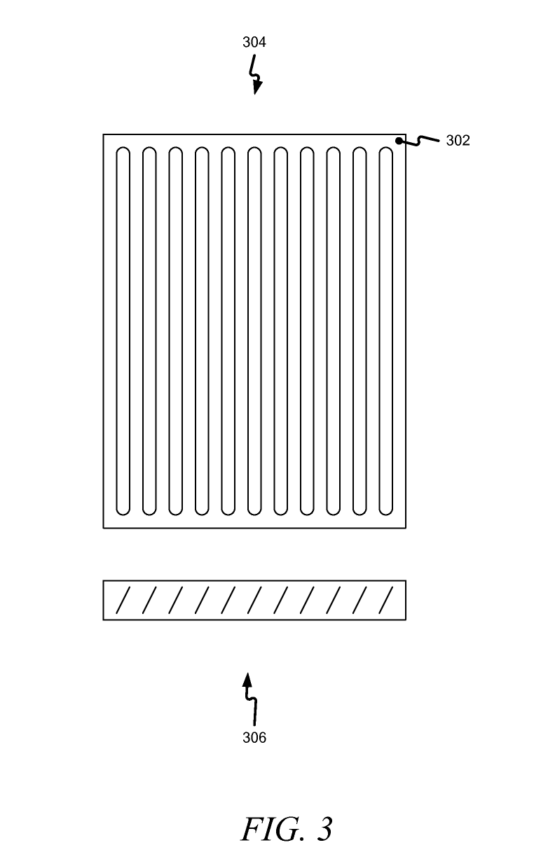

For example and as shown in FIG. 3, cascade pan 142 may comprise a surface 302 having a plurality of openings 304. Cascade pan 142 may be arranged such that surface 302 may be located proximate fan 146. A portion of the air exiting fan 146's exhaust may pass through cascade pan 142. For instance, during operation of combine 100, fan 146 may deliver air at a specific volumetric flow rate or a range of volumetric flow rates. The air may cause stratification of the grain and MOG.

The stratification may be caused by density differences between the grain and MOG. For example, corn kernels may have a higher density the stalk or cob. As the air passes through cascade pan 142, the denser kernels may fall through the updraft at a faster rate than the stalk or cob. Suspending the MOG in the airflow may allow another fan, or duct connected to fan 146, to assist in moving the MOG toward the read of combine 100 for discarding.

Plurality of openings 304 may have a size sufficient to selectively allow material to pass through plurality of openings 304. In other words, cascade pan 142 may act as a sift that may help separate the grain from the MOG. In addition, plurality of openings 304 may have a size to allow air to through surface 302 and allow grain to pass through plurality of openings 304. For example, during operation of combine 100, fan 146 may blow air through cascade pan 142 (i.e., through plurality of openings 304). As the air is passing through cascade pan 142, grain may pass through plurality of opening 304 and be collected by clean grain auger 150.

Cascade pan 142 may vibrate. The vibration may assist in separating the grain from the MOG. For example, cascade pan 142 may vibrate and the vibrations may cause the MOG to bounce up into the airflow created by fan 146. In addition, the vibrations may case the grain to move in a direction toward sieve 148 and clean grain auger 150.

As shown in FIG. 3, plurality of openings 304 may be formed as a plurality of vanes 306. Plurality of vanes 306 may be fixed or adjustable. For example, plurality of vanes 306 may be louvered. The louvers may allow an operator of combine 100 to better control the airflow passing through surface 302.

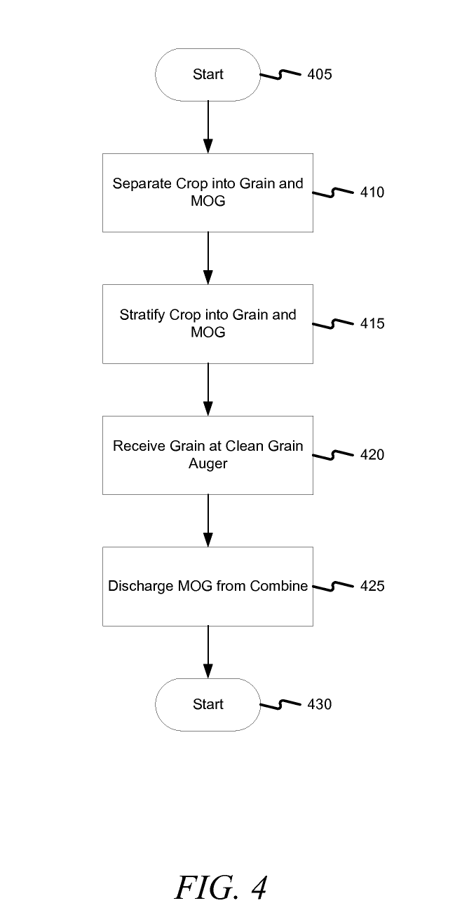

FIG. 4 shows a flowchart for a method 400 for separating grain from MOG. Method 400 may begin at stage 405 where a crop (e.g., corn) may be separated, via a rotor in threshing section 128, into grain and MOG. From stage 405 where the crop is separated into grain and MOG, method 400 may proceed to stage 415 where the grain and MOG may be stratified.

As described above, stratification of the grain and MOG may be accomplished blowing air through cascade pan 142. The airflow may be opposite a direction of travel the grain and the MOG may be traveling. For instance, the grain and MOG may be traveling in a downward direction and the air may be traveling in an upward direction.

Stratification of the grain and MOG may also be accomplished by sifting the grain and MOG. For example, cascade pan 142 may vibrate, either by a vibration inducing element (e.g., a motor) or naturally (the movement of combine 100 across a field). The vibrations may cause plurality of openings 304 and surface 302 to act as a sift, and thereby stratify the grain and MOG.

In addition, stratification may be enhanced by adjusting the airflow through plurality of openings 304. For example, plurality of vanes 306 may be adjusted to increase or decrease the airflow. The adjustments may be automated. For example, an onboard computer located in combine 100 may control actuators that may adjust plurality of vanes 306's position.

From stage 415 where the grain and MOG are stratified, method 400 may proceed to stage 420 where the grain may be received at clean grain auger 150. From stage 420 where the grain is received at clean grain auger 150, method 400 may proceed to stage 420 where the MOG may be discharged from combine 100. Method 400 may the terminal at ending block 430.

An embodiment may comprise an apparatus. The apparatus may comprise a surface located proximate a fan having an exhaust. The surface may comprise an upper portion arranged above a lower portion. The surface may define a plurality of openings and may be arranged to receive a portion of air exiting the exhaust.

Another embodiment may comprise an apparatus. The apparatus may comprise a combine having a fan having an exhaust, a rotor pan located above the exhaust, a sieve located below the rotor pan and below the exhaust, and a surface. The fan may be arranged to blow air into the exhaust. The surface may be located proximate a fan having an exhaust. The surface may comprise an upper portion arranged above a lower portion. The surface may define a plurality of openings and be arranged to receive a portion of air exiting the exhaust.

Yet another embodiment may comprise a method. The method may comprise: separating, within a rotor, a crop into grain and material other than grain (MOG); and stratifying the grain and MOG as the grain and MOG travel from the rotor to a cascade pan.

Both the foregoing general description and the following detailed description are examples and explanatory only, and should not be considered to restrict the invention's scope, as described and claimed. Further, features and/or variations may be provided in addition to those set forth herein. For example, embodiments may be directed to various feature combinations and sub-combinations described herein.

All rights, including copyrights, in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example embodiments.

What is claimed is:

1. An apparatus comprising:
a fan having an exhaust, the fan arranged to blow air into the exhaust;
a rotor pan locate above the exhaust;
a sieve located below the rotor pan and below the exhaust; and
a surface defining a plurality of openings, the surface located proximate the exhaust and arranged to receive a portion of the air blown into the exhaust.

2. The apparatus of claim 1, wherein the surface is configured to vibrate.

3. The apparatus of claim 2, wherein the surface being configured to vibrate comprises the surface vibration being configured to direct the grain toward the sieve.

4. The apparatus of claim 1, wherein the surface arranged to receive the portion of the air blown into the exhaust comprises the surface being configured to receive the portion at a volumetric flow rate to cause stratification of grain and material other than grain (MOG).

5. The apparatus of claim 1, wherein the surface defining the plurality openings comprises the surface defining the plurality of openings having a size sufficient to selectively allow grain to pass through the plurality of openings.

6. The apparatus of claim 1, wherein the surface defining the plurality openings comprises the surface being configured to allow the portion of the air to pass through the surface and substantially simultaneously allow grain to pass through the plurality of openings.

7. The apparatus of claim 1, wherein the surface is located within an agricultural machine.

8. The apparatus of claim 7, wherein the agricultural machine is a combine.

9. An apparatus comprising:
a combine comprising:
a fan having an exhaust, the fan arranged to blow air into the exhaust,
a rotor pan locate above the exhaust, and
a sieve located below the rotor pan and below the exhaust; and
a surface comprising an upper portion arranged above a lower portion and the fan, the surface defining a plurality of openings, the surface located proximate the exhaust and arranged to receive a portion of the air blown into the exhaust.

10. The apparatus of claim 9, wherein the surface is configured to vibrate.

11. The apparatus of claim 10, wherein the surface being configured to vibrate comprises the surface vibration being configured to direct the grain toward the sieve.

12. The apparatus of claim 9, wherein the surface arranged to receive the portion of the air comprises the surface being configured to receive the portion at a volumetric flow rate to cause stratification of grain and material other than grain (MOG).

13. The apparatus of claim 9, wherein the surface defining the plurality openings comprises the surface defining the plurality of openings having a size sufficient to selectively allow grain to pass through the plurality of openings.

14. The apparatus of claim 9, wherein the surface defining the plurality openings comprises the surface being configured to allow the portion of the air to pass through the surface and substantially simultaneously allow grain to pass through the plurality of openings.

15. A method comprising:
separating, within a rotor, a crop into grain and material other than grain (MOG); and
stratifying the grain and MOG as the grain and MOG travel from the rotor to a cascade pan.

16. The method of claim 15, wherein stratifying the grain and the MOG comprises blowing air through the cascade pan opposite a direction of travel the grain and the MOG travel.

17. The method of claim 15, further comprising sifting the grain and the MOG.

18. The method of claim 17, wherein sifting the grain and the MOG comprises passing a portion of the grain though holes defined by the cascade pan.

19. The method of claim 17, wherein sifting the grain and the MOG comprises:
passing a portion of the grain though holes defined by the cascade pan; and
blowing air through the cascade pan opposite a direction of travel the grain and the MOG travel.

20. The method of claim 15, further comprising vibrating the cascade pan.
